(19) United States
(12) Patent Application Publication
(10) Pub. No.: US 2025/0123139 A1
(43) Pub. Date: Apr. 17, 2025

(54) SYSTEM AND METHOD FOR MONITORING OF AN OBJECT/STRUCTURE BY MEASUREMENT OF VIBRATIONS USING AN OPTICAL FIBER

(71) Applicant: ENI S.P.A., Roma (IT)

(72) Inventors: Massimo ZAMPATO, Venezia (VE) (IT); Axel TUROLLA, Venezia (VE) (IT); Stefano CARMINATI, San Donato Milanese (MI) (IT); Luca PALMIERI, Selvazzano Dentro (PD) (IT)

(21) Appl. No.: 18/688,110

(22) PCT Filed: Sep. 21, 2022
(86) PCT No.: PCT/IB2022/058922

§ 371 Date: Feb. 29, 2024

(30) Foreign Application Priority Data
Sep. 22, 2021 (IT) 102021000024347

(51) Int. Cl. G01H 9/00; G01D 5/353

(52) U.S. Cl. CPC G01H 9/004; G01D 5/35358

(57) ABSTRACT

A system and method for monitoring by optical fiber for the measurement of vibrations an object/structure includes the optical fiber associated with the object/structure and one end connected to a circulator and a terminated opposite end, a source of symbols emitting sequence of N_{S} input signals and configured to generate an input vector, a multi-carrier OFDM modulation block adapted to modulate a light beam emitted by a laser source by an OFDM modulating signal to determine a sensing signal with N_{C} subcarriers, the modulating signal OFDM being generated on the basis of the input vector; the circulator adapted to send the sensing signal to the optical fiber and to receive a backscattered signal; an OFDM demodulation block; and a processing unit that processes the output and input vectors, on the basis of respective Nc reference vectors of the optical fiber, generating a deformation vector.

### CROSS-REFERENCE TO RELATED APPLICATIONS

This application is a 35 U.S.C. § 371 National Stage patent application of PCT/IB2022/058922, filed on 21 Sep. 2022, which claims the benefit of Italian patent application 102021000024347, filed on 22 Sep. 2021, the disclosures of which are incorporated herein by reference in their entirety.

### TECHNICAL FIELD

The present disclosure relates to a system and method for monitoring by optical fiber an object/structure for the measurement and localization of even isolated, high-frequency vibrations.

The field of application is generally the monitoring of objects/structures subject to micro-crack phenomena such as composite tanks, pipelines for the transport of fluids, oil wells, wind turbines, concrete structures, historical buildings and other structures or similar objects.

### BACKGROUND

Various systems and methods using acoustic sensors distributed along a transmission channel of optical fiber are known for the detection of vibration events. These systems employ methodologies of the type “acoustic sensing” or DAS acronym for Distribution Acoustic Sensing, as for example described in the book by A. Hartog, “An Introduction to Distributed Optical Fibre Sensors”, CRC Press, 2018.

Such known solutions are satisfactory in various aspects and used to detect medium or low frequency events. The detectable band or frequency is related to the time interval it takes for the light to travel back and forth in the transmission channel or optical connection. For example, for a 3 km long optical connection the detectable acoustic band is limited to about 17 kHz.

There is interest in increasing the measurement band to detect events that are considered at high or very high frequency, i.e. events that reach, for example, on the same optical connection lengths, of about 3 km, bands of not less than 500 kHz.

A known solution to increase the measurement band is described in the article by L. Marcon et al., “High-frequency high-resolution distributed acoustic sensing by optical frequency domain reflectometry” (Opt. Express, vol. 27, pp. 13923-13933, May 2019, doi: 10.1364/OE.27.013923). The solution involves using an OFDR scheme, acronym for Optical Frequency Domain Reflectometry with a high coherence laser that can be tuned on a band of a few tens of nanometers. This solution can be used for extremely short optical connection lengths and is therefore hardly applicable in the technical field of interest. In addition, continuous measurements over time require the use of two laser sources in parallel and high-capacity processing boards. These requirements entail extremely high costs, so the transportability in the field is very critical and of little interest.

Other known solutions are described in the article by P. Ma et al., “Probabilistic Event Discrimination Algorithm for Fiber Optic Perimeter Security Systems” (Journal of Lightwave Technology, vol. 36, no. 11, pp. 2069-2075, 1 Jun. 2018, doi: 10.1109/JLT.2018.2802324).

These solutions are based on interferometric schemes that require access from both ends of the optical connection and therefore cannot be used for measurements, for example in the well. This naturally reduces the applicability of the solutions described.

An other solution is described in the article by di C. Dorize et al: “An OFDM-MIMO Distributed Acoustic Sensing over Deployed Telecom Fibers”, 2021 Optical Fiber Communications conference and Exhibition (OFC), OSA, 6 Jun. 2021, pages 1-3, XP033947695, and in the European patent application EP3694117A1 “Multi-carrier coherent coded distributed acoustic sensing” filed by Nokia Technologies OY [FI] and published on 12 Aug. 2020. An other solution is described in the article by M. Wu et al: “Frequency Response Enhancement of Phase-Sensitive OTDR for interrogating Weak Reflector Array by Using OFDM and Vernier Effect”, published in the “Journal of Lightwave Technology”, IEEE, vol. 38, n. 17, 9 May 2020, pages 4874-4882, XP011806617.

For the above reasons, the systems and the methods of the prior art are not satisfactory for detecting high and very high frequency events by optical fiber with optical connection lengths over one kilometer and with a single input/output access to which the present disclosure relates.

The technical problem underlying this application is that of devising a system and a method having structural and functional characteristics such as to optimally satisfy the need to detect microcracks generated by high and very high frequency events in objects/structures, overcoming the drawbacks mentioned with reference to the prior art.

### SUMMARY

The idea of solution underlying the present disclosure is to consider a non-perturbed condition of the object/structure as a reference for the measurement of a perturbation.

Based on this solution idea, the technical problem is solved by a system for monitoring by optical fiber of an object/structure for the measurement of vibrations as defined by an independent claim.

Other preferred embodiments of the system are described by the dependent claims.

A monitoring method using optical fiber for the measurement of vibrations of an object/structure as defined by another independent claim and dependent claims is also an object of the disclosure.

### BRIEF DESCRIPTION OF THE DRAWINGS

Further features and advantages of the disclosure will result from the following description of a preferred embodiment of the system and of the method and variants thereof provided by way of example with reference to the accompanying drawings, wherein:

FIG. 1 is a schematic block view of a system made according to the present disclosure;

FIGS. 2 and 3 schematically show a processing unit of the system of FIG. 1 in two different operating steps;

FIG. 4 is a graph representing a perturbation or vibration applied to an object/structure and the perturbation or vibration estimated according to the present disclosure.

### DETAILED DESCRIPTION OF THE DRAWINGS

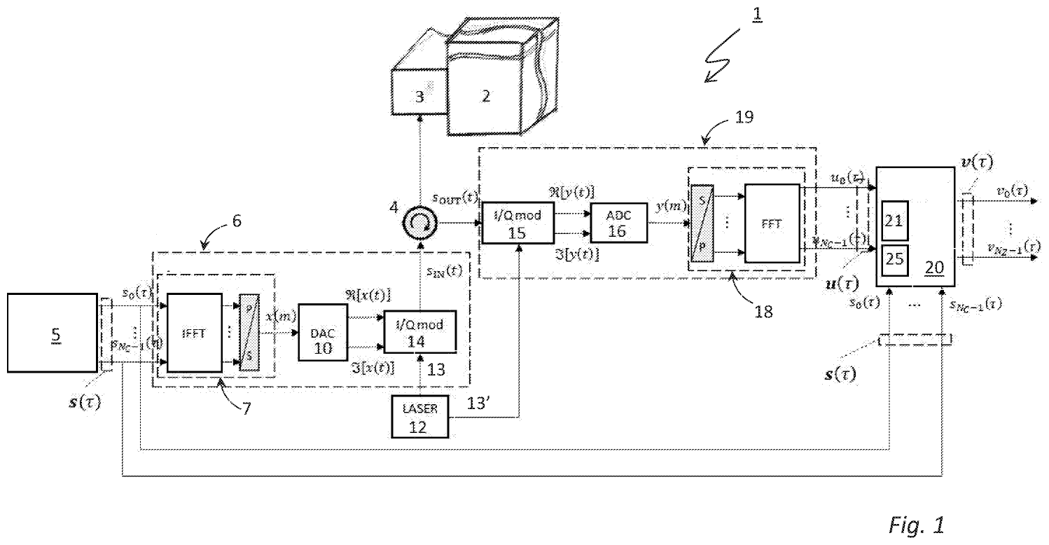

With reference to FIG. 1, a system for monitoring by optical fiber 3 of an object/structure 2 made according to the present disclosure is schematically illustrated and globally indicated with the number 1. The monitoring system 1 is used in particular, but not exclusively, for the measurement of even isolated, high or very high frequency vibrations in objects/structures 2.

In the embodiment illustrated in FIG. 1, indicative and not represented in scale, the object/structure 2 to be monitored develops substantially perpendicular to the plane of the sheet and may include tanks, wind turbines, concrete structures, historical buildings and other similar but may also include structures of considerable size such as pipelines for the transport of fluids, oil wells, track structures and the like.

The optical fiber 3 is associated with the object/structure 2 and constitutes a waveguide with length L that is calculated between an end associated with a circulator 4 and a terminated opposite end. The opposite end of the optical fiber 3 is suitably terminated to obtain a maximum reflectivity of the backscattered signals generated by the optical fiber 3 by, for example, Rayleigh scattering.

The monitoring system 1 comprises a source of symbol 5 which emits in a continuous way, N_{C} input signals sₙ(τ) n=[0, . . . , N_{C}−1] defining an input vector s(τ). Each input signal sₙ(τ) comprises a repeating sequence of N_{S} input symbols oi i=[0, . . . , N_{S}−1]. The generated N_{S} input symbols σᵢ are preferably complex and with predefined values for each sequence of the 10 repeated sequences.

According to one embodiment, the repeated sequences in each signal of said N_{C} input signals sₙ(τ) n=[0, . . . , N_{C}−1] are equal to each other. Moreover, the predefined sequences comprise the same number N_{S} of input symbols σᵢ i=[0, . . . , N_{S}−1]. In an embodiment, a same sequence with translated symbols σᵢ is repeated in each signal of said Nc input signals sₙ(τ). Thus for instance, the symbols of the sequence of the input signal sₙ(τ) are translated with respect to the symbol of the sequence of the first input signal s₀(τ) by a number equal to the index n—with n=[0, . . . , N_{C}−1]—of the signal input.

In particular, each input symbol σᵢ is generated for a duration T which is defined by the formula:

$$T = \frac{1}{γ {B}_{A}}$$

wherein γ is an integer, preferably equal to 10, and B_{A} is the acoustic band characterizing the optical fiber 3.

The monitoring system 1 further comprises a multi-carrier OFDM modulation block 6 that allows generating an OFDM sensing signal S_{IN}(t) with N_{C} subcarriers. The OFDM sensing signal S_{IN}(t) is generated by modulating a light beam 13 emitted by a laser source 12 by means of an OFDM modulating signal x(m), multi-carrier. The OFDM digital modulating signal x(m) is generated on the basis of the input vector s(τ) using the OFDM technique, acronym for Orthogonal Frequency Division Multiplexing. Thus, the OFDM digital modulating signal x(m), is a complex-sampled multi-carrier signal with a number N_{C} orthogonal subcarriers. The OFDM digital modulating signal x(m) comprises a continuous sequence of input symbols or samples wherein m is the sampling index determined with a sampling frequency equal to F_{S}=1/T₀=N_{C}/T wherein T is the duration of the symbol σᵢ and T₀ is the duration of the OFDM sample.

The circulator 4 sends the multi-carrier sensing signal S_{IN}(t) to the optical fiber 3 and receives a multi-carrier backscattered signal S_{OUT}(t) generated by the optical fiber 3 as backscattering of the sensing signal S_{IN}(t). Each Nc subcarrier of the backscattered signal S_{OUT}(t) comprises an output sequence of backscattered symbols εᵢ for i=[0, . . . , N_{S}−1] which are subsequently extrapolated.

The optical fiber 3 is divided in length L into a number N_{Z} of subsequent points which define N_{Z} spatial discretization cells in which parameters of said optical fiber 3 are estimated, as will be clearer in the following description.

The number N_{Z} can be correlated with some parameters of the optical fiber 3 according to the equation:

$${N}_{z} = \frac{2 γ L {B}_{A}}{{v}_{g}}$$

wherein
L is the length of the optical fiber 3;
γ is a predefined variable, according to an embodiment equal to 10;
B_{A} is the appropriately measurable acoustic band which can be equal to B_{A}≈1/(γT) preferably with y equal to 10, of course different values of y can be considered,
v_{g} is a group speed of said optical fiber 3, i.e. the speed at which the energy/information is transported by the optical fiber 3 and depends on the physical properties of the optical fiber 3 itself.

With the optical fiber 3 divided into N_{Z} spatial discretization cells, the spatial resolution δ_{Z} is equal to:

δ_{Z}=L/N_{Z}

An OFDM demodulation block 19 receives the light beam 13 from the laser source 12 to demodulate the backscattered signal S_{OUT}(t) by extracting a demodulated signal, which may be analog (R[y(t)], I[y(t)]) or digital y(m)). The set of the demodulated signals extracted for each of said N_{C} subcarriers determines an output vector u(τ) comprising N_{C} output signals uₙ(τ) n=[0, . . . , N_{C}−1]. Each of the N_{C} output signals uₙ(τ) comprises sequences with backscattered symbols εᵢ for i=[0, . . . , N_{S}−1].

A processing unit 20 receives the output vector u(τ) with the N_{C} output signals uₙ(τ) n=[0, . . . , N_{C}−1] and the input vector s(τ) with N_{C} input signals sₙ(τ) n=[0, . . . , N_{C}−1] and, on the basis of N_{C} reference vectors, R̅ₙ n=[0, . . . , N_{C}−1], generates a deformation vector v(τ) of the optical fiber 3, that is

$$v ( τ ) = {[ {v}_{0} ( τ ) , {v}_{1} ( τ ) … {v}_{{N}_{z} - 1} ( τ ) ]}^{T}$$

wherein N_{Z} is the number of points at which the optical fiber 3 is estimated. The deformation vector v(τ) therefore comprises deformation values for each spatial discretization cell of the optical fiber 3.

The N_{C} reference vectors, R̅ₙ n=[0, . . . , N_{C}−1], are determined or estimated for each spatial discretization cell. Thus, the deformation vector v(τ) comprises N_{Z} perturbation signals of the optical fiber 3 divided by spatial discretization cells. According to one embodiment, the N_{C} reference vectors, R̅ₙ n=[0, . . . , N_{C}−1], are defined by considering the object/structure 2 unperturbed, i.e. not subject to vibrations or deformations and thus in other words by considering the optical fiber 3 under static conditions.

The deformation vector v(τ) thus obtained makes it possible to determine the deformation of the object/structure 2 both with regard to the entity, i.e. the physical magnitude of the perturbation, deformation or vibration, and with regard to the position or zone of interest in the length L of the optical fiber 3. Furthermore, it is possible to determine the course of the perturbation over time τ by analysing the deformation vector v(τ).

In the embodiment of FIG. 1, the monitoring system 1 comprises an OFDM modulation block 6 with an OFDM modulation unit 7 equipped with an IFFT (Inverse Fast Fourier Transform) module and a parallel converter/P/S series. The OFDM modulation block 7 processes the N_{C} input signals sₙ(τ) of the input vector s(τ) and determines the OFDM digital modulating signal x(m).

The OFDM modulation block 6 further comprises an analog digital converter or DAC 10 and an I/Q electronic optical modulator 14.

The DAC converter 10 receives the OFDM digital modulating signal x(m) and generates the OFDM analog modulating signal, that comprises two signals R[x(t)] and I[x(t)], multicarrier with N_{C} orthogonal subcarriers.

In each subcarrier N_{C} of the OFDM analog modulating signal, R[x(t)] and I[x(t)], the predefined sequences comprising a number N_{S} of said input symbols oi are repeatedly transmitted.

Preferably, the optical source 12 is equipped with a high coherence laser emitting the light beam 13.

The I/Q modulator 14 modulates the light beam 13, which is received from the optical source 12, by means of the OFDM analog modulating signals, R[x(t)], I[x(t)], to generate the sensing signal S_{IN}(t) comprising N_{C} subcarriers.

The probe signal S_{IN}(t) is transmitted to the optical fiber 3 through the circulator device 4.

The optical fiber 3 being terminated generates a backscattered signal S_{OUT}(t) which will be correlated to the probe signal S_{IN}(t) by the transfer function of the optical fiber 3 itself.

In each of the N_{c} subcarriers of the sensing signal S_{IN}(t) the sequences of N_{S} symbols included in the respective input signals sₙ(τ) are repeatedly transmitted

$${\underline{s}}_{n} ( τ ) = [ {s}_{n} ( τ ) , {s}_{n} ( τ - 1 ) , … {s}_{n} ( τ - {N}_{S} + 1 ) ]$$

According to an illustrative and non-limiting embodiment, the sequences of N_{S} symbols may be represented by a constellation of symbols according to modulation systems of the PSK Phase-shift keying QAM or or Quadrature Amplitude Modulation digital phase modulation type.

The OFDM demodulation block 19 comprises an I/Q opto-electronic demodulator 15 that receives from the circulator 4 the backscattered signal S_{OUT}(t), comprising Nc subcarriers, and it further receives a second light beam 13′ emitted by the laser source 12 to extract an OFDM demodulated backscattered signal, which comprises two analog signals [symbol] [y(t)] and [symbol] [y(t)]. The second light beam 13′ has an intensity proportional to the intensity of the light beam 13.

By means of an ADC analog digital converter 16, the OFDM demodulated backscattered signal [symbol] [y(t)] and [symbol] [y(t)] is digitised to generate a digital OFDM output signal y(m). The digital OFDM output signal y(m) comprises a sequence of samples in which m is the sampling index.

The ADC converter 16 has a sampling frequency equal to F_{S}=N_{C}/T where T is the sampling index of each input signal sₙ(τ) and N_{C} is the number of OFDM subcarriers.

By means of an OFDM demodulation unit 18, comprising a series/parallel converter and an FFT (Fast Fourier Transformer) module, the OFDM output vector u(τ) is determined from the OFDM output signal y(m)

$$u ( τ ) = {[ {u}_{0} ( τ ) , {u}_{1} ( τ ) … {u}_{{N}_{c} - 1} ( τ ) ]}^{T}$$

comprising N_{C} output signals uₙ(τ) n=[0, . . . , N_{C}−1] with each output signal comprising N_{S} backscattered symbols Ei for i=[0, . . . , N_{C}−1]

According to one embodiment, the processing unit 20 substantially module 21 and a comprises a processing calibration module 25. The two modules are activated for two distinct procedures:
1. the processing module 21 is activated for an estimation procedure to estimate the perturbation response of the optical fiber 3 during the measurement period of the vibration of the object/structure 2;
2. the calibration module 25 is activated for calibration procedure that allows to estimate the response of the optical fiber 3 unperturbed, i.e. with the object/structure 2 free of vibrations and/or perturbations, by determining the reference vectors R̅ₙ n=[0, . . . , N_{C}−1] for each of the Nc subcarriers.

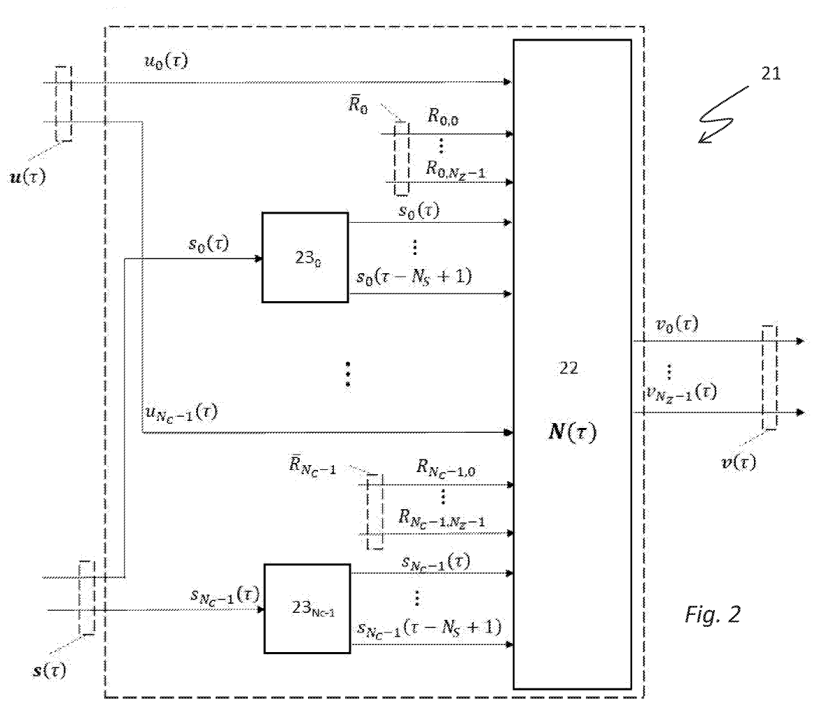

According to the embodiment illustrated in FIG. 2, the processing module 21 comprises a perturbation estimation block 22 which receives as input:
the output vector u(τ) with the N_{C} output signals uₙ(τ) n=[0, . . . , N_{C}−1] of backscattered symbols uᵢ(τ);

$$u ( τ ) = {[ {u}_{0} ( τ ) , {u}_{1} ( τ ) … {u}_{{N}_{c} - 1} ( τ ) ]}^{T} ;$$

the N_{C} reference vectors R̅ₙ=[R_{n,0}, R_{n,1} . . . . R_{n, N}_{_{Z}}₋₁] estimated using the calibration procedure, which will be described later, and calculated for each spatial discretization cell in which optical fiber 3 is divided;
N_{C} vectors of antecedent symbols s̅ₙ(τ)=[sₙ(τ), sₙ(τ-1) . . . sₙ(τ−N_{S}+1)] obtained from respective first sliding window blocks 23ₙ with n=0, . . . , N_{C}−1.

Each first sliding window block 23, receives the respective input signal sₙ(τ) from the source of symbols 5 and generates the corresponding vector of antecedent symbols s̅ₙ(τ). The vector of antecedent symbols s̅ₙ(τ) comprises N_{S} input symbols preceding the symbol at the time τ of the input signal sₙ(τ).

The perturbation estimation block 22 processes the inputs to output the deformation vector v(τ)

$$v ( τ ) = {[ {ν}_{0} ( τ ) , {v}_{1} ( τ ) … {ν}_{{N}_{z} - 1} ( τ ) ]}^{T}$$

which comprises an estimation of the perturbation for each spatial discretization cell in which the optical fiber 3 is divided.

According to one embodiment, the deformation vector v(τ) is determined using the circular matrices i.e:

$$v ( τ ) = {( {N}^{T} ( τ ) N ( τ ) )}^{- 1} {N}^{T} ( τ ) u ( τ )$$

wherein a computation matrix N(τ) is defined by:

$$N ( τ ) = [ \begin{matrix}{\overline{s}}_{0} ( τ ) ∘ {\overline{R}}_{0} \\ {\overline{s}}_{1} ( τ ) ∘ {\overline{R}}_{1} \\ ⋮ \\ {\overline{s}}_{{N}_{c} - 1} ( τ ) ∘ {\overline{R}}_{{N}_{c} - 1}\end{matrix} ]$$

The calculation matrix N(τ) is a matrix N_{C}×N_{Z} in which the rows s̅ₙ(τ)∘R̅ₙ are obtained with the Hadamard product i.e. element by element among the values included in said vectors of antecedent Ns symbol sₙ(τ) n=[0, . . . , N_{C}−1] and in the reference vectors R̅ₙ n=[0, . . . , N_{C}−1].

Considering the vectors of N_{S} antecedent symbols s̅ₙ(τ):

$${\overline{s}}_{n} ( τ ) = [ {s}_{n} ( τ ) , {s}_{n} ( τ - 1 ) … {s}_{n} ( τ - {N}_{S} + 1 ) ]$$

the circulating matrix Ŝₙ(τ) associated with each vector of antecedent symbols s̅ₙ(τ) must have full rank, i.e. the rows, which are cyclic permutations of the vector of antecedent initial signals s̅ₙ(τ) must be linearly independent of each other.

Furthermore, to generate a matrix N(τ) with full rank, considering that the reference vectors R̅ₙ n=[0, . . . , N_{C}−1] are very similar to each other, it is preferable to send on each of the N_{c} subcarriers the same sequence of symbols of the first subcarrier translated by a number equal to the index N_{c} of the subcarrier itself, i.e. according to the equation:

$${\overline{s}}_{n} ( τ ) = {\overline{s}}_{0} ( τ - n )$$

Thus, it is possible to exploit the properties that derive from the use of the calculation matrix N(τ) with full rank, with no null eigenvalues, in which the rows of the matrix are linearly independent of each other.

In this way, the deformation vector v(τ) has a structure given by:

$$v ( τ ) = {[ 1 , … 1 , {e}^{j 2 ϕ ( τ )} , {e}^{j ϕ ( τ ) ϕ ( τ - 1 )} , … , {e}^{j ϕ ( τ ) ϕ ( τ - {N}_{z} - {κ}_{0} )} ]}^{T}$$

Note that the element of the deformation vector corresponding to the spatial discretization cell (κ₀+1) is

$${v}_{{κ}_{0} + 1} ( τ ) = {e}^{j 2 ϕ ( τ )}$$

where ϕ(τ) is the signal proportional to the strain of the perturbation or vibration associated with the portion of object/structure 2 corresponding to the spatial discretization cell (κ₀+1).

Thus, the deformation vector v(τ) makes it possible to determine the intensity or deformation of the perturbation or of the vibration to which the object/structure 2 is subjected. Furthermore, the position of the perturbation is obtained by analysing the discretization cells as well as the time course of the perturbation determined by analysing instead the perturbation vector v(τ) in the time intervals T.

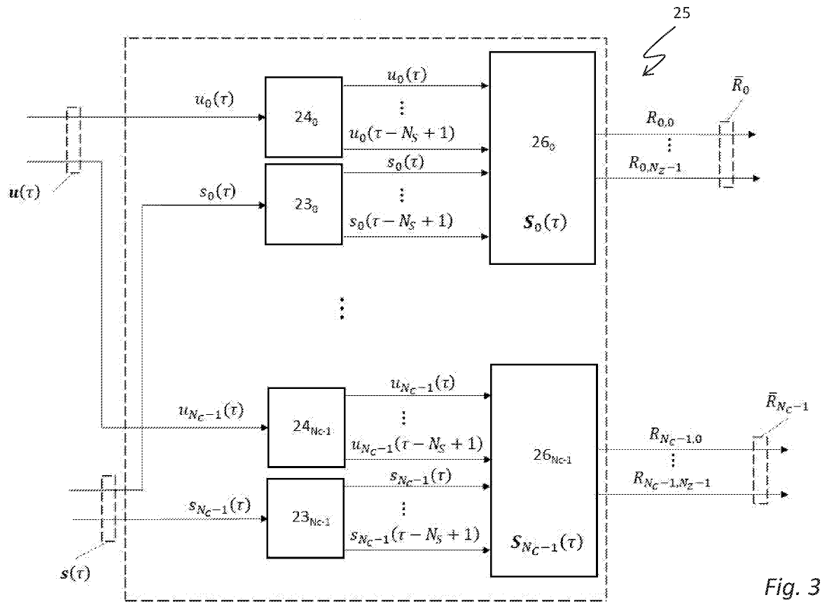

FIG. 3 illustrates an embodiment of the calibration module 25 that is configured to estimate the reference vector R̅ₙ n=[0, . . . , N_{C}−1] for each of the N_{c} subcarriers of the sensing signal S_{IN}(t).

Each reference vector R̅ₙ with n=[0, . . . , N_{C}−1]

$${\overline{R}}_{n} = [ {R}_{n , 0} , {R}_{n , 1} … {R}_{n , {N}_{Z} - 1} ]$$

is calculated with the object/structure 2 unperturbed, therefore not subjected to vibrations or perturbations. In the present embodiment, the reference vector R̅ₙ comprises complex values.

The calibration module 25 receives as input the N_{C} input signals sₙ(τ) n=[0, . . . , N_{C}−1] of the input vector s(τ) and by means of the N_{C} first sliding window blocks 23ₙ n=[0 . . . . N_{C}−1], generates the N_{C} vectors of antecedent symbols s̅ₙ(τ)= [sₙ(τ), sₙ(τ−1) . . . sₙ(τ−N_{S}+1)].

Furthermore, the calibration module 25 receives the output vector u(τ) with the N_{c} output signals uₙ (τ) n=[0, . . . , N_{C}−1]

$$u ( τ ) = {[ {u}_{0} ( τ ) , {u}_{1} ( τ ) … {u}_{{N}_{C} - 1} ( τ ) ]}^{T}$$

and by means of respective N_{C} second sliding window blocks 24ₙ, with n=[0 . . . N_{C}−1], it generates N_{c} vectors of antecedent backscattered symbols:

$${\overline{u}}_{n} ( τ ) = {[ {u}_{n} ( τ ) , {u}_{n} ( τ - 1 ) … {u}_{n} ( τ - {N}_{S} + 1 ) ]}^{T} with n = 0 … {N}_{C} - 1.$$

The calibration module 25 comprises N_{C} estimation blocks 26ₙ, with n=[0 . . . N_{C}−1], adapted to estimate the reference vector R̅ₙ or signature (Fiber signature) of the optical fiber 3. The reference vector R̅ₙ or signature is estimated for each Nc subcarrier at each spatial discretization cell.

Each estimation block 26ₙ n=[0 . . . N_{C}−1] generates the corresponding reference vector Ry with n=[0 . . . N_{C}−1]

$${\overline{R}}_{n} = [ {R}_{n , 0} , {R}_{n , 1} … {R}_{n , {N}_{Z} - 1} ]$$

calculated by

$${\overline{R}}_{n} = {( {S}_{n}^{T} ( τ ) {S}_{n} ( τ ) )}^{- 1} {S}_{n}^{T} ( τ ) {\overline{u}}_{n} ( τ )$$

wherein Sₙ(τ) is a matrix N_{S}×N_{z} obtained from the circulating matrix Ŝₙ(τ) associated with the vector of initial antecedent symbols sₙ(τ) by eliminating the last (N_{S}−N_{z}) columns. A circulating matrix associated with the vector of antecedent initial symbols s̅ₙ(τ) is a square matrix such that each row of Ŝₙ(τ) is a circular translation of a sample of the first row.

In one embodiment, the calibration module 25 uses the N_{c} first sliding window blocks 23, of the processing module 21. Alternatively, in an embodiment not illustrated, the calibration module 25 can use further first sliding window blocks.

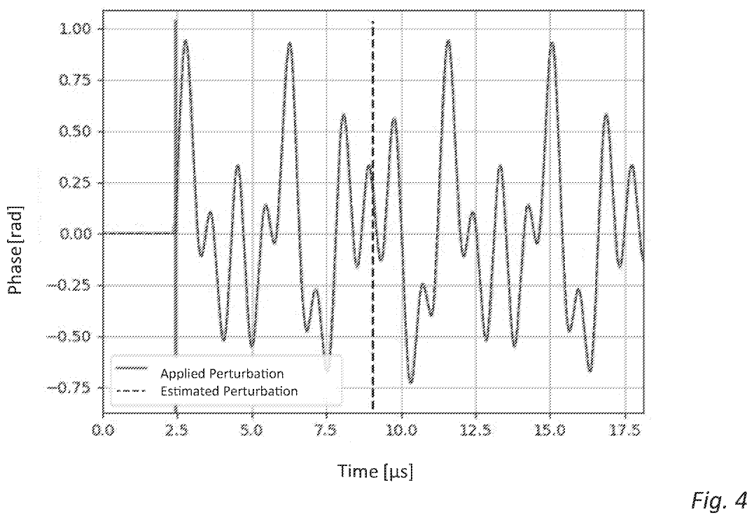

The Applicant has been able to observe that the monitoring system, according to the present disclosure, allows an accurate estimation of the perturbation as is evident from the graph of FIG. 4 in which a substantial overlap is observed between the perturbation generated by a vibration applied to an object/structure, illustrated with a solid line below, and an estimated perturbation, illustrated with a dashed line and which is superimposed on the solid line for the entire path.

Calculation Matrix N(τ) and Sₙ(τ) with Full Rank

By way of illustration and not limitation, bearing in mind that the eigenvalues of a circulating matrix associated with the vector sₙ(0) are the coefficients ŝₙ(0) of the IDFT of sₙ(0), to generate a calculation N(τ) or Sₙ(τ) full-rank matrix, with no null eigenvalues, N_{S} coefficients îₙ(0) are selected making sure that each of them is non-zero; the DFT of the vector of the coefficients ŝₙ(0) is calculated and the resulting vector sₙ(0) satisfies the full rank condition. This mode allows wide discretion in the choice of the coefficients ŝₙ(0). For example, the coefficients can be selected so that the elements of the resulting vector sₙ(0) have a module that is not too dissimilar to each other.

Alternatively, circulating simplex codes can be used as described for example in the article by Song, Golomb, “Some new constructions for simplex codes,” IEEE Trans. Inf. Theory, 1994. The simplex codes are a set of vectors at equal distances from each other that make up the vertices of a simplex.

Alternatively, the Zadoff-Chu sequences can also be used which are used in LTE mobile telephony systems and described in the article by Chu, “Polyphase codes with good periodic correlation properties,” IEEE Trans. Inf. Theory, 1972 and in the article by Song, Shen, Jia, “Evolved Cellular Network Planning and Optimization for UMTS and LTE” 2011.

The disclosure also refers to a monitoring method using optical fiber for the measurement of vibrations of an object/structure. The measurement of vibrations essentially defines a mapping of the optical fiber with the determination of the position and of the intensity of even isolated, very high-frequency vibrations. For example, frequencies higher than 500 kHz are considered for a length L of the optical fiber equal to 3 km.

In the following description of the method, details and co-operating parts having the same structure and function as the parts included in the system, described above, will be indicated by the same reference numbers and abbreviations.

The monitoring method provides:
associating the optical fiber 3 with the object/structure 2, said optical fiber 3 comprising an end connected to a circulator 4 and a terminated opposite end, and
generating an input vector s(τ) with N_{C} input signals sₙ(τ) n=[0, . . . , N_{C}−1] comprising Ns input symbols σᵢ i=[0, . . . , N_{S}]), said input symbols being generated, in a continuous way, by a source of symbols 5.

The method also provides:
determining a sensing signal S_{IN}(t) with N_{C} subcarriers by modulating a light beam 13, generated by a laser source 12, by means of an OFDM modulating signal which is generated on the basis of said N_{C} input signals sₙ(τ) n=[0, . . . , N_{C}−1] of the input vector s(τ).

The method provides generating an OFDM analog modulating signal, which comprises two signals R[x(t)], I[x(t)], by means of an OFDM modulation of said N_{c} input signals sₙ(τ) n=[0, . . . , N_{C}−1]. An OFDM digital modulating signal x(m) is obtained by means of an analogue digital sampling of the OFDM analog modulating signal, R[x(t)], I[x(t)]). The OFDM digital modulating signal x(m) comprises a sequence of samples in which m is the sampling index determined with a sampling frequency equal to F_{S}=1/T₀=N_{C}/T wherein T is the duration of the symbol σᵢ and T₀ is the duration of the OFDM sample.

The method therefore provides:
probing the optical fiber (3) by sending the sensing signal (S_{IN}(t)) multi-carrier, and by receiving, again through the circulator 4, a backscattered signal S_{OUT}(t) with N_{C} subcarriers.

Thus, the method provides:
determining an output vector u(τ) with N_{C} output signals uₙ(τ) n=[0, . . . , N_{C}−1] by demodulating with OFDM Orthogonal Frequency Division Multiplexing demodulation the backscattered signal S_{OUT}(t) by means of a second light beam 13′ with intensity proportional to the intensity of the light beam 13; and
generating a deformation vector v(τ) of the optical fiber (3) by processing the output vector u(τ) and the input vector s(τ) on the basis of respective N_{C} reference vectors R̅ₙ n=[0, . . . , N_{C}−1] of the optical fiber 3. Said N_{C} reference vectors R̅ₙ n=[0, . . . , N_{C}−1] are determined for each of said N_{C} subcarriers considering unperturbed conditions of the optical fiber 3. The method also provides estimating the deformation vector v(τ) on the basis of:
said output vector u(τ) with the N_{C} output signals uₙ(τ) n=[0, . . . , N_{C}−1],
said N_{C} predefined reference vectors R̅ₙ n=[0, . . . , N_{C}−1],
N_{C} vectors of antecedent symbols s̅ₙ(τ) generated by respective first sliding window blocks 23ₙ, with n=0, . . . , N_{C}−1, receiving respective input signals sₙ(τ) n=[0, . . . , N_{C}−1] of the input vector s(τ).

Furthermore, the method provides for a calibration procedure that allows to estimate for each subcarrier Nc of the sensing signal S_{IN}(t) a corresponding reference vector R̅₀, . . . , R̅_{Nc-1} calculated with said unperturbed optical fiber 3.

The calibration procedure provides:
generating N_{C} vectors of antecedent symbols s̅ₙ(τ) using N_{C} first sliding window blocks 23ₙ, with n=0 . . . . N_{C}−1, which receive respective input signals sᵢ(τ);
generating N_{C} vectors of antecedent backscattered symbols ūₙ(τ) using N_{C} second sliding window blocks 24ₙ n=0 . . . . N_{C}−1 which receive respective output signals uᵢ(τ);
dividing the optical fiber 3 in length L into N_{z} spatial discretization cells;
generating a corresponding reference vector R̅ₙ for each spatial discretization cell of each N_{C} subcarrier using N_{c} estimation blocks 26ₙ, with n=0 . . . . N_{C}−1, said estimation blocks 26ₙ being configured to receive corresponding vectors of antecedent symbols s̅ₙ(τ) and corresponding vectors of antecedent backscattered symbols ūₙ(τ).

Calculating said reference vector R̅ₙ by means of the equation

$${\overline{R}}_{n} = {( {S}_{n}^{T} ( τ ) {S}_{n} ( τ ) )}^{- 1} {S}_{n}^{T} ( τ ) {\overline{u}}_{n} ( τ )$$

wherein Sₙ(τ) is a matrix N_{S}×N_{z} comprises the circulating matrix Ŝₙ(t) associated with the vector of antecedent symbols s̅ₙ(τ) by eliminating the last (N_{S}−N_{z}) columns, each circulating matrix Ŝₙ(t) associated with each vector of antecedent initial symbols s̅ₙ(τ) having full rank.

### Conditions for the System and for the Method Described

The length L of the optical fiber 3 and the specific value of the acoustic band B_{A} fix the minimum period of time T of the predefined sequence comprising the number N_{S} of input symbols σᵢ i=[0, . . . , N_{S}−1] of the input signals sᵢ(τ) according to the following equation:

$${N}_{S} \geq {N}_{Z} = \frac{2 γ {LB}_{A}}{{v}_{g}} ;$$

Furthermore, the total band of the multi-carrier OFDM sensing signal S_{IN}(t) is proportional to the square of the acoustic band of the optical fiber 3 according to the equation:

$${B}_{TOT} = \frac{200 γ L}{{v}_{g}} {B}_{A}^{2} .$$

As an example, purely by way of illustration and not limitation, to obtain an acoustic band B_{A}=1 MHZ on an optical fiber of length L=3 km it is necessary to have OFDM input symbols of duration T=100 ns which correspond to a spatial resolution δz=10 m and a minimum number of subcarriers N_{C}=300.

The total band of the OFDM signal is therefore B_{TOT}≈3 GHz.

1. A system for monitoring by optical fiber an object/structure for the measurement of vibrations, the system comprising:
said optical fiber associated with said object/structure and having one end connected to a circulator and a terminated opposite end;
a source of symbols emitting N_{C} input signals (sₙ(τ) n=[0, . . . , N_{C}−1]) with each input signal comprising sequences of input symbols (σᵢ i=[0, . . . , N_{S}−1]), said N_{C} input signals (sₙ(τ) n=[0, . . . , N_{C}−1]) generating an input vector (s(τ));
a multi-carrier OFDM-Orthogonal Frequency Division Multiplexing-modulation block that receives said input vector (s(τ)) and that is configurated to modulate a light beam emitted by a laser source by means of an OFDM modulating signal (x(m); R[x(t)], I[x(t)]) to determine a sensing signal (s_{IN}(t)) with N_{C} subcarriers, said OFDM modulating signal being generated on the basis of the input vector (s(τ));
said circulator being adapted to send said sensing signal (s_{IN}(t)) to said optical fiber and to receive a backscattered signal S_{OUT} (t) with N_{C} subcarriers;
an OFDM demodulation block which receives said backscattered signal S_{OUT} (t) and a second light beam of intensity proportional to the intensity of said light beam, said OFDM demodulation block being configured to demodulate the backscattered signal (S_{OUT} (t)) determining an output vector (u(τ)) with N_{C} output signals (uₙ(τ) n=[0, . . . , N_{C}−1]) which include backscattered symbols (εᵢ i=[0, . . . , N_{C}−1]);
a processing unit which receives said output vector (u(τ)) and said input vector (s(τ)), the processing unit on the basis of respective N_{c} reference vectors (R̅ₙ n=0, . . . , Nc−1) of said optical fiber and of N_{C} vectors of antecedent symbols(s) (s̅ₙ(τ)) of said sensing signal (s_{IN}(t)) generates a deformation vector (v(τ)) of said optical fiber which allows to determine said vibration measurement, said N_{c} reference vectors (R̅ₙ n=[0, . . . , N_{C}−1]) being determined for each of said N_{C} subcarriers of said sensing signal (s_{IN}(τ)) considering unperturbed conditions of said optical fiber.

2. The system according to claim 1, wherein said OFDM modulation block comprises:
an OFDM modulation unit which is configured to receive and process said N_{C} input signals (sₙ(τ) n=[0, . . . , N_{C}−1]) to determine an OFDM digital modulating signal (x(m)) with N_{C} orthogonal subcarriers, each digital modulating signal OFDM (x(m)) comprising a continuous sequence of said N_{S} input signals (σᵢ i=[0, . . . , N_{S}−1]);
a digital analog converter which is configured to receive the OFDM digital modulating signal (x (m)) to generate a multi-carrier OFDM analog modulating signal (R[x(t)], I[x(t)]) with N_{C} orthogonal subcarriers; and
an opto-electronic modulator I/Q which receives said OFDM analog modulating signal (R[x(t)], I[x(t)]) and is configured to modulate said light beam and to generate said multi-carrier sensing signal (s_{IN}(t)).

3. The system according to claim 1, wherein said OFDM demodulation block comprises:
an opto-electronic demodulator I/Q which receives said backscattered signal (S_{OUT}(t)) with N_{C} subcarriers and said second light beam, the opto-electronic demodulator I/Q is to generate an OFDMR analogue demodulated backscattered signal ( [symbol] [y(t)], [ [symbol] [y(t)]) with N_{C} subcarriers;
an analog to digital converter that is configured to digitize said OFDM analogue demodulated backscattered signal ( [symbol] [(t)], [symbol] [y(t)]) generating an OFDM digital output signal (y(m)) with each subcarrier comprising a continuous sequence of said backscattered symbols (εᵢ i=[0, . . . , N_{S}−1]); and
an OFDM demodulation unit which is configured to receive and demodulate said OFDM digital output signal (y(m)) in order to generate the output vector (u(τ)) that comprises said N_{C} output signals (uₙ(τ) n=[0, . . . , N_{C}−1]).

4. The system according to claim 1, wherein said optical fiber is divided in length (L) into a number Nz of subsequent points which define N_{Z} spatial discretization cells, said deformation vector (v(τ)) comprising deformation values for each spatial discretization cell, said number N_{Z} being calculated by means of the equation
$${N}_{Z} = \frac{2 γ {LB}_{A}}{{v}_{g}}$$
wherein
L is the length of said optical fiber;
γ is a predefined variable;
B_{A} is the measurable acoustic band of said optical fiber; and
v_{g} is a group speed of said optical fiber.

5. The system according to claim 1, wherein said processing unit is equipped with a processing module comprising a perturbation estimation block, said perturbation estimation block being configured to generate said deformation vector (v(τ)) by receiving:
said output vector (u(τ)) with said N_{C} output signals (uₙ(τ) n=[0, . . . , N_{C}−1]);
said N_{C} reference vectors (R̅ₙ n=[0, . . . , N_{C}−1]) of said optical fiber,
N_{C} vectors of antecedent symbols (s̅ₙ(τ) obtained from respective first sliding window blocks (23ₙ with n=0, . . . , N_{C}−1) receiving respective input signals (sₙ(τ) n=[0, . . . , N_{C}−1]) of said input vector (s(τ)).

6. The system according to claim 4, wherein said perturbation estimation block comprises an estimate of the perturbation for each spatial discretization cell of said optical fiber, said deformation vector (v(τ)) being determined using circular matrices according to the equation:
$$v ( τ ) = {( {N}^{T} ( τ ) N ( τ ) )}^{- 1} {N}^{T} ( τ ) u ( τ )$$
wherein a computation matrix N(τ) is defined by:
$$N ( τ ) = [ \begin{matrix}{\overline{s}}_{0} ( τ ) ∘ {\overline{R}}_{0} \\ {\overline{s}}_{1} ( τ ) ∘ {\overline{R}}_{1} \\ ⋮ \\ {\overline{s}}_{{N}_{C} - 1} ( τ ) ∘ {\overline{R}}_{{N}_{C} - 1}\end{matrix} ]$$
said calculation matrix N(τ) being a matrix (N_{C}×N_{z}) with N_{c} the number of carriers and N_{z} the number of said carriers discretization cell into which the optical fiber is divided, the rows (s̅ₙ(τ)∘R̅ₙ) of said calculation matrix (N(τ)) being obtained by multiplying the vectors of antecedent symbols 5, (x) by the reference vectors (R̅ₙ n=[0, . . . , N_{C}−1]), each of said reference vectors (R̅ₙ n=[0, . . . , N_{C}−1]) comprising a reference value for each discretization cell of said optical fiber.

7. The system according to claim 6, wherein each circulating matrix (Ŝₙ (τ)) associated with each vector of antecedent initial symbols (s̅ₙ(τ))) has full rank.

8. The system according to claim 7, wherein each of said subcarriers comprises a sequence of input symbols (sᵢ(τ)) of the first subcarrier translated by a number of times equal to the N_{C} index of the subcarrier itself, according to the equation:
$${\overline{s}}_{n} ( τ ) = {\overline{s}}_{0} ( τ - n )$$

9. The system according to claim 1, wherein said processing unit comprises a calibration module configured to estimate for each subcarrier Nc of said sensing signal (s_{IN}(t)) a corresponding reference vector (R̅ₙ, . . . , R̅_{N,e-1}) calculated with said unperturbed optical fiber, said calibration module comprising:
N_{C} first sliding window blocks (23ₙ n=0 . . . N_{C}−1) which are configured to receive respective input signals (sₙ(τ)) n=[0, . . . , N_{C}−1]) and to generate corresponding vectors of antecedent symbols (s̅ₙ(τ));
N_{C} second sliding window blocks (24ₙ n=0 . . . N_{C}−1) which receive respective output signals (ūₙ(τ) n=[0, . . . , N_{C}−1]) to generate corresponding vectors of antecedent backscattered symbols (ūₙ(τ)); and
N_{C} estimation blocks (26ₙ n=0 . . . N_{C}−1) configured to receive corresponding vectors of antecedent symbols (s̅ₙ(τ)) and corresponding vectors of antecedent backscattered symbols (ūₙ(τ)) to generate a corresponding reference vector (R̅ₙ) for each discretization cell of each subcarrier N_{C}, said reference vector (R̅ₙ) being calculated by:
$${\overline{R}}_{n} = {( {S}_{n}^{T} ( τ ) {S}_{n} ( τ ) )}^{- 1} {S}_{n}^{T} ( τ ) {\overline{u}}_{n} ( τ )$$
wherein Sₙ(τ) is a matrix N_{S}×N_{z} obtained from the circulating matrix Ŝₙ(τ) associated with the vector of antecedent symbols (s̅ₙ(τ)) by eliminating the last (N_{S}−N_{z}) columns.

10. A monitoring method using optical fiber for the measurement of vibrations of an object/structure, the method including the following steps:
associating with said object/structure said optical fiber which comprises an end connected to a circulator and a terminated opposite end,
generating an input vector (s(τ)) with N_{C} input signals (sₙ(τ) n=[0, . . . , N_{C}−1]) including sequences of input symbols (σᵢ i=[0, . . . , N_{S}−1),
determining a sensing signal (S_{IN}(t)) with N_{C} subcarriers by modulating a light beam by an OFDM Orthogonal Frequency Division Multiplexing modulation by means of an OFDM modulating signal (x(m); R[x(t)], I[x(t)]), generating said OFDM modulating signal (x(m); R[x(t)], I[x(t)]) on the basis of said input vector (s(τ)),
probing said optical fiber by sending said sensing signal (s_{IN}(t)) and by receiving a backscattered signal S_{OUT} (t) with N_{C} subcarriers,
determining an output vector (u(τ)) with N_{C} output signals (uₙ(τ) n=[0, . . . , N_{C}−1]), demodulating said backscattered signal (S_{OUT} (t)) by an OFDM demodulation by means of a second light beam with intensity proportional to said light beam, said N_{C} output signals (uₙ(t) n=[0, . . . , N_{C}−1]) comprising backscattered symbols (εᵢ i=[0, . . . , N_{S}−1]), and
generating a deformation vector (v(τ)) by processing said output vector (u(τ)) and said input vector (s(τ)) on the basis of respective Ne reference vectors (R̅ₙ n=[0, . . . , N_{C}−1]) of said optical fiber and of N_{C} vectors of antecedent symbols (s̅ₙ(τ)) of said sensing signal (s_{IN}(t)), said N_{c} reference vectors (R̅ₙ n=[0, . . . , N_{C}−1]) being determined for each of said N_{C} subcarriers of said sensing signal (s_{IN}(t)) considering unperturbed conditions of said optical fiber.

11. The method according to claim 10, wherein estimating said deformation vector (v(τ)) is on the basis of:
said output vector u(τ) with said N_{C} output signals (uₙ(τ) n=[0, . . . , N_{C}−1]);
said N_{C} reference vectors (R̅ₙ, n=[0, . . . , N_{C}−1]),
said N_{C} vectors of antecedent symbols (s̅ₙ(τ)) which are obtained from corresponding first sliding window blocks (23ₙ con n=0, . . . , N_{C}−1) receiving respective input signals (sₙ(τ) n=[0, . . . , N_{C}−1]) of said input vector (s(τ)).

12. The method according to claim 10, wherein estimating for each subcarrier Nc of said sensing signal (s_{IN}(t)) a corresponding reference vector (R̅ₙ n=[0 . . . N_{C}−1]) is calculated with said unperturbed optical fiber, said reference vector (R̅ₙ n=[0 . . . N_{C}−1]) being calculated by providing the following steps:
generating Nc vectors of antecedent symbols (s̅ₙ(τ)) using N_{C} first sliding window blocks (23ₙ n=[0 . . . N_{C}−1]) which receive respective input signals (sₙ(τ) n=[0, . . . , N_{C}−1]),
generating N_{C} vectors of antecedent backscattered symbol (ūₙ(τ)) using N_{C} second sliding window blocks (24ₙ n=[0 . . . N_{C}−1]) which receive respective output signals (uₙ(τ) n=[0, . . . , N_{C}−1]),
dividing said optical fiber in length L into N_{z} spatial discretization cells,
generating a corresponding reference vector (R̅ₙ n=[0, . . . , N_{C}−1]) for each discretization cell of each Nc subcarrier using N_{C} estimation blocks (26ₙ n=[0 . . . N_{C}−1]) configured to receive corresponding vectors of antecedent symbols (s̅ₙ(τ)) and corresponding vectors of antecedent backscattered symbols (ūₙ(τ)), and
calculating said reference vector (R̅ₙ) by means of the equation
$${\overline{R}}_{n} = {( {S}_{n}^{T} ( τ ) {S}_{n} ( τ ) )}^{- 1} {S}_{n}^{T} ( τ ) {\overline{u}}_{n} ( τ )$$
wherein Sₙ(τ) is a matrix N_{S}×N_{z} comprising the circulating matrix Ŝₙ(τ) associated with the vector of antecedent initial symbols s̅ₙ(τ) and eliminating the last (N_{S}−N_{z}) columns, each circulating matrix (Ŝₙ(τ)) associated with each vector of antecedent initial symbols (s̅ₙ(τ)) having full rank.
